(19) United States
(12) Patent Application Publication
(10) Pub. No.: US 2005/0003710 A1
(43) Pub. Date: Jan. 6, 2005

(54) Power module for motor vehicles

(75) Inventors: Christopher L. Congdon, Fishers, IN (US); Ralph H. Johnston, Anderson, IN (US); David A. Fulton, Anderson, IN (US)

Correspondence Address: Thomas A. Walsh;Ice Miller, One American Square, Box 82001, Indianapolis, IN, 46282-0002, US

(73) Assignee: Delco Remy America, Inc., Anderson, IN (US)

(21) Appl. No.: 10/884,761

(22) Filed: Jul. 2, 2004

Related U.S. Application Data
(60) Provisional application No. 60/484,719, filed on Jul. 3, 2003.

(51) Int. Cl. H01R 13/66

(52) U.S. Cl. 439/620

(57) ABSTRACT

A power module is connected to the starter, and generator of a motor vehicle. The power module is housed in a casing made of an insulative material. The power module includes a capacitor and an isolation circuit. The capacitor is connected to the starter when the ignition switch is closed to provide cranking current to the starter. The isolation circuit allows current to flow from the battery to the capacitor, but prevents current flow in the opposite direction. The capacitor is quickly recharged when the engine reaches an increased speed. Therefore, the capacitor is available to provide cranking current to a vehicle even when the vehicle repeatedly stops and starts over a short period of time.

This application claims the benefit of U.S. Provisional Patent Application Ser. No. 60/484,719, filed Jul. 3, 2003, the disclosure of which is incorporated by reference.

### BACKGROUND

The present invention relates to the field of motor vehicles, and particularly to electrical power systems for motor vehicles.

During normal operation of a motor vehicle, the battery is used to provide electric current to crank the engine during starting. Once the engine starts and begins running at increased speeds, the vehicle alternator re-charges the battery so the battery will have plenty of charge for the next start. However, in situations where the engine starts and stop many times over a short period of time, drained batteries are often encountered because the alternator does not have sufficient opportunity to re-charge the battery. Drained batteries not only result in the need for jump starts, but also tend to shorten battery life.

Delivery vehicles are particularly susceptible to drained batteries since the nature of activities associated with delivery vehicles involves repeated stopping and re-starting the vehicle as numerous deliveries are made with only short distances between each stop. As discussed above, the repeated starting and stopping of the delivery vehicle engine subjects the vehicle battery to an unusually high number of discharge cycles. Because the driving time between stops is typically short, there is little time to re-charge the battery during those driving times. Near the end of the day, once a delivery vehicle has made numerous starts and stops, the battery in the vehicle is often drained and cannot provide the current required to crank the engine. The result is that the operator of the delivery vehicle must have the vehicle jump-started or towed to a maintenance facility. Accordingly, it would be advantageous to provide a system that supplements a traditional battery in an automotive vehicle (delivery vehicle or otherwise) so the vehicle battery does not have to provide all the energy for starting the engine.

### SUMMARY

In an embodiment, the present invention comprises an electrically conductive isolation device, the electrically conductive isolation device comprising a first connection point and a second connection point, wherein flow of electric current from the first connection point to the second connection point is permitted, and flow of electric current from the second connection point to the first connection point is resisted; means for storing an electric charge, the means for storing an electric charge comprising a positive lead and a negative lead, the means for storing an electric charge having a capacitance of less than 321 farads, the positive lead electrically connected to the second connection point of the electrically conductive isolation device; means for electrically connecting the positive lead to an external electric load; means for electrically connecting the negative lead to ground; and means for electrically connecting the first connection point of the electrically conductive isolation device to a positive terminal of an external DC voltage source.

In an embodiment, the present invention comprises a starter motor; a generator; a battery, the battery having a positive terminal and a negative terminal, the positive terminal electrically connected to the generator; an electrically conductive isolation device, the electrically conductive isolation device comprising a first connection point and a second connection point, wherein flow of electric current from the first connection point to the second connection point is permitted, and flow of electric current from the second connection point to the first connection point is resisted, the first connection point of the electrically conductive isolation device electrically connected to the positive terminal of the battery, the first connection point of the electrically conductive isolation device electrically connected to the generator; means for storing an electric charge, the means for storing an electric charge comprising a positive lead and a negative lead, the means for storing an electric charge having a capacitance of less than 321 farads, the positive lead electrically connected to the second connection point of the electrically conductive isolation device, the negative lead electrically connected to ground; and means for electrically connecting the positive lead to the starter motor.

In an embodiment, the present invention comprises means for storing an electric charge, the means for storing an electric charge comprising a positive lead and a negative lead, the negative lead electrically connected to ground; and a rechargeable DC voltage source comprising a positive terminal and a negative terminal, the negative terminal electrically connected to the negative lead, the rechargeable DC voltage source connected in parallel with the means for storing an electric charge, wherein the means for storing an electric charge and the rechargeable DC voltage source are contained in unitary package.

In an embodiment, the present invention comprises means for storing an electric charge, the means for storing an electric charge comprising a positive lead and a negative lead, the negative lead electrically connected to ground; a rechargeable DC voltage source comprising a positive terminal and a negative terminal, the negative terminal electrically connected to the negative lead; and an electrically conductive isolation device, the electrically conductive isolation device comprising a first connection point and a second connection point, wherein flow of electric current from the first connection point to the second connection point is permitted, and flow of electric current from the second connection point to the first connection point is resisted, the first connection point electrically connected to the positive terminal, the second connection point electrically connected to the positive lead, wherein the means for storing an electric charge, the electrically conductive isolation device, and the rechargeable DC voltage source are contained in unitary package.

In an embodiment, the present invention comprises a starter motor; a generator; and a unitary power module, the unitary power module comprising (i) an electrically conductive isolation device, the electrically conductive isolation device comprising a first connection point and a second connection point, wherein flow of electric current from the first connection point to the second connection point is permitted, and flow of electric current from the second connection point to the first connection point is resisted, the first connection point of the electrically conductive isolation device electrically connected to the generator, (ii) means for storing an electric charge, the means for storing an electric charge comprising a positive lead and a negative lead, the positive lead electrically connected to the second connection point of the electrically conductive isolation device, the negative lead electrically connected to ground, and (iii) a first battery, the first battery comprising a first positive terminal and a first negative terminal, the first negative terminal electrically connected to the negative lead, the first positive terminal electrically connected to the first connection point of the electrically conductive isolation device.

In aspects of the foregoing embodiments of the present invention, the electrically conductive isolation device comprises a diode. In aspects of the foregoing embodiments of the present invention, the electrically conductive isolation device comprises an arrangement of electrically interconnected active components. In aspects of the foregoing embodiments of the present invention, the means for storing an electric charge comprises at least one electric double layer capacitor. In aspects of the foregoing embodiments of the present invention further comprises a voltage booster connected in parallel with the electrically conductive isolation device.

### BRIEF DESCRIPTION OF THE DRAWINGS

The features and advantages of this invention, and the methods of obtaining them, will be more apparent and better understood by reference to the following descriptions of embodiments of the invention, taken in conjunction with the accompanying drawings, wherein:

FIG. 1 is a block diagram of the connections between the electrical system of a motor vehicle and a power module for motor vehicles according to an embodiment of the present invention;

FIG. 2 is a schematic showing the connections between the electrical components in an embodiment of a power module according to the present invention;

FIG. 3A is a schematic showing the connections between the electrical components in an embodiment of a power module according to the present invention;

FIG. 3B is a schematic showing the connections between the electrical components in an embodiment of a power module according to the present invention;

FIG. 3C is a schematic showing the connections between the electrical components in an embodiment of a power module according to the present invention;

FIG. 3D is a schematic showing the connections between the electrical components in an embodiment of a power module according to the present invention;

FIG. 3E is a schematic showing the connections between the electrical components in an embodiment of a power module according to the present invention;

FIG. 3F is a schematic showing the connections between the electrical components in an embodiment of a power module according to the present invention;

FIG. 4 is an elevational view of a power module housing showing the physical arrangement of components in an embodiment of a power module according to the present invention;

FIG. 5 is a plan view of the power module housing showing the physical arrangement of components in an embodiment of a power module according to the present invention; and

FIG. 6 is a block diagram of the connections between an embodiment of a power module according to the present invention and the electrical system of a motor vehicle, where the power module has replaced the vehicle's standard battery.

### DESCRIPTION

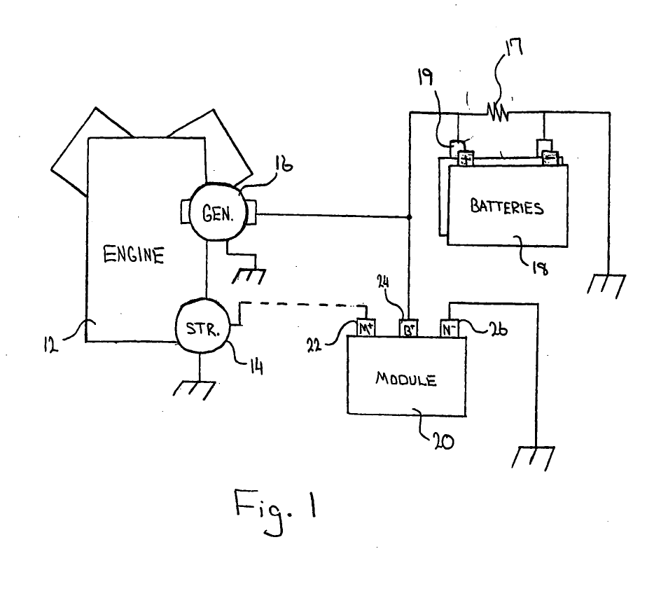

FIG. 1 shows a block diagram of an embodiment of a vehicle electrical system having a power module 20 positioned therein. The electrical system includes a starter motor 14 connected to the vehicle engine 12. The starter motor 14 receives electrical current and rotates to crank the vehicle engine 12. A generator 16 is also connected to the vehicle engine. Once the engine 12 has started, the generator 16 is driven by the engine 12 and provides electric current to the vehicle electrical system. A vehicle battery 18 is connected to the generator 16 such that the battery can be charged by the electrical current delivered from the generator. Vehicle loads 17 are connected across the battery.

As shown in FIG. 1, an embodiment of the power module 20 is connected to the starter 14, generator 16, and vehicle battery 18. The power module 20 is housed in a nonconductive casing and includes three terminals. The three terminals of the power module 20 include a B(+) terminal 24, a M(+) terminal 22, and a Neg(−) terminal (i.e., ground terminal) 26. The B(+) terminal 24 is connected to the battery terminal of the generator 16 and the positive terminal 19 of the vehicle battery 18. The M(+) terminal 22 is connected to the battery terminal of the starter motor 14. A switch (not shown) is located in the electrical connection between the M(+) terminal 22 and the starter 14, and connection between the M(+) terminal 22 and the starter 14 is made and broken by operation of the switch. (For this reason the connection between the M(+) terminal 22 and the starter is represented by dotted lines in FIG. 1.) The switch between the M(+) terminal 22 and the starter 14 is controlled by the ignition switch (not shown) such that the connection between the M(+) terminal 27 and the starter 14 is made when the ignition switch is closed and broken when the ignition switch is open.

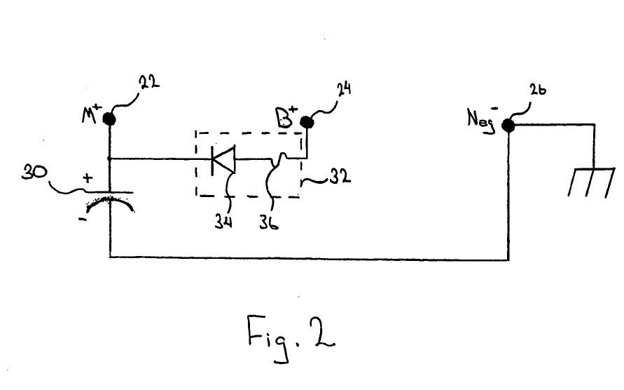

An arrangement of electrical components within an embodiment of the power module 20 is shown in FIG. 2. A capacitor 30 is positioned within the module 20 housing with the positive lead/terminal of the capacitor 30 connected to the M(+) terminal 22 and the negative lead/terminal of the capacitor 30 connected to the Neg(−) terminal 26. The capacitor 30 is an electric double layer capacitor of the type commonly referred to as a “super capacitor.” In an alternative embodiment, the capacitor 30 comprises a bank of capacitors. In one embodiment, the capacitor/capacitor bank has a total capacitance of about 283 farads.

An isolation circuit (represented by dotted lines 32) is also positioned within the housing that contains power module 20. The isolation circuit 32 comprises a diode 34 connected in series with a fuse 36. Fuse 36 is optional in this arrangement. The isolation circuit connects the B(+) terminal 24 to the M(+) terminal 22 within the housing of the module 20. The positioning of the diode 34 in the isolation circuit allows current to flow from the B(+) terminal 24 to the M(+) terminal 22, but prevents current flow in the opposite direction. This isolates the capacitor 30 from the vehicle battery 18, and prevents the capacitor 30 from discharging into the vehicle battery 18.

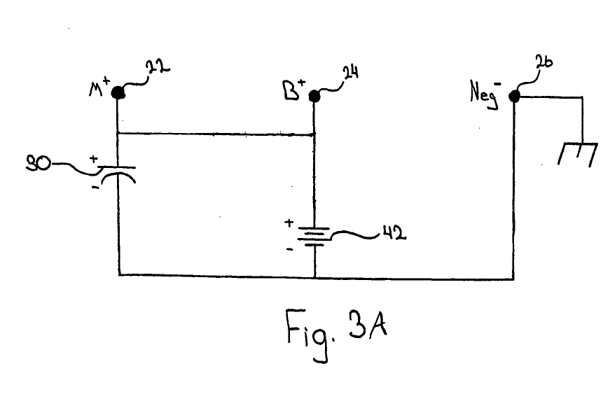

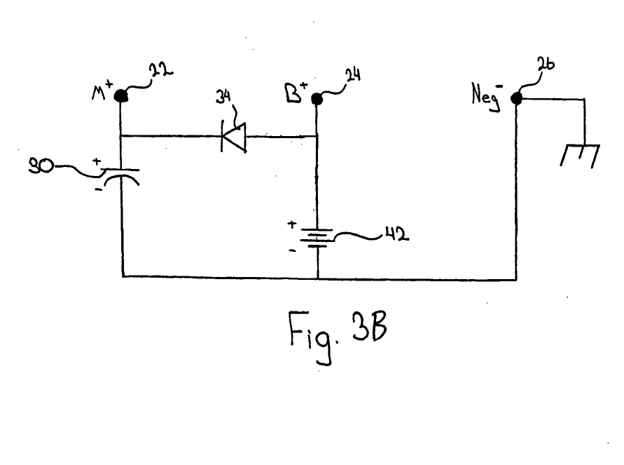

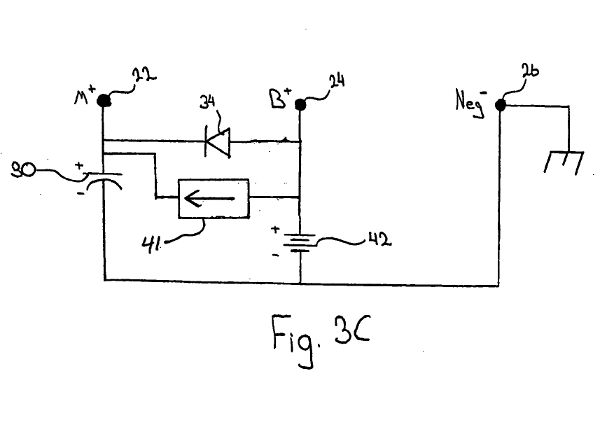

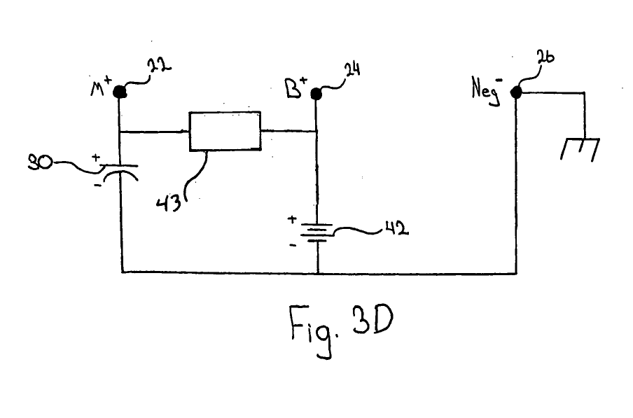

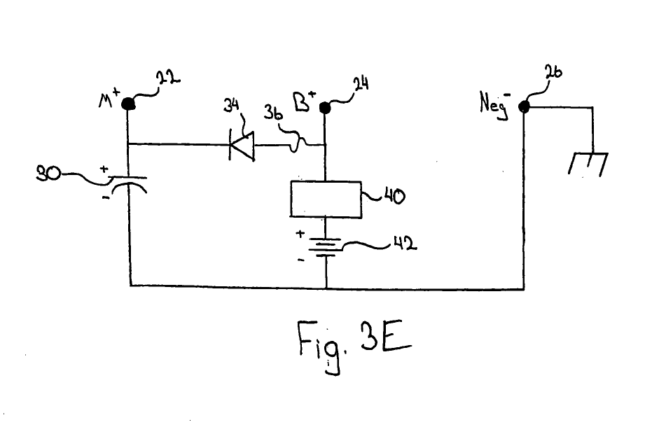

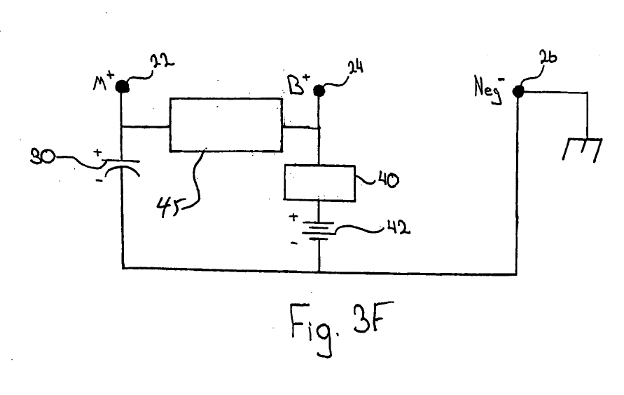

An alternative arrangement for the electrical components in the module 20 is shown in FIG. 3A. A power module battery 42 is connected in parallel with the capacitor 30. There is no isolation circuit in this arrangement. The power module battery 42 provides an additional source for charging the capacitor 30 and provides supplementary starting current for the starter motor 14. Use of the power module battery 42 allows the size of the capacitor 30 (or capacitor bank) in the module to be reduced, since starting current is not completely dependent upon the capacitor 30. Power module battery 42 may comprise one or more rechargeable batteries of types known in the art. For example, power module battery 42 may comprise one or more lead-acid batteries (vented and non-vented), one or more deep cycle batteries, one or more nickel-cadmium batteries (vented and non-vented), one or more nickel-metal hydride batteries, one or more nickel-iron batteries, one or more nickel-zinc batteries, one or more silver-zinc batteries, one or more silver-cadmium batteries, one or more nickel-hydrogen batteries, and/or one or more lithium ion batteries.

Another alternative arrangement for the electrical components in the module 20 is shown in FIG. 3B. Capacitor 30 and power module battery 42 are connected as was shown in the arrangement of FIG. 3A. Diode 34 is connected between the B(+) terminal 24 and the M(+) terminal 22 as shown. The positioning of the diode 34 in the isolation circuit isolates the capacitor 30 from the power module battery 42.

Another alternative arrangement for the electrical components in the module 20 is shown in FIG. 3C. Capacitor 30, power module battery 42, and diode 34 are connected as was shown in the arrangement of FIG. 3B. In addition, voltage booster 41 is added to power module 20 as shown. Voltage booster 41 compensates for the voltage drop through diode 34 to boost the rate at which the capacitor 30 recharges. It will be noted that the functions of diode 34 and voltage booster 41 may be combined in a single circuit.

Another alternative arrangement for the electrical components in the module 20 is shown in FIG. 3D. Capacitor 30 and power module battery 42 are connected as was shown in the arrangement of FIG. 3A. Low-loss isolation circuit 43 is connected between the B(+) terminal 24 and the M(+) terminal 22 as shown. The positioning of the low-loss isolation circuit 43 in the isolation circuit isolates the capacitor 30 from the power module battery 42, but does so in a way that may be more efficient than diode 34. Low-loss isolation circuit 43 comprises an arrangement of active components selected to reduce the losses/voltage drops relative to using a diode. For example, loss isolation circuit 43 may comprise a pulse wave modulator or DC chopper circuit. Low-loss isolation circuit 43 may serve to limit the contribution of the power module battery 42 to the cranking/starting of the vehicle. Low-loss isolation circuit 43 could also limit the current passed to the capacitor 30 during recharging.

Another alternative arrangement for the electrical components in the module 20 is shown in FIG. 3E. Capacitor 30, power module battery 42, and diode 34 are connected as was shown in the arrangement of FIG. 3B. A charge circuit 40 is connected between power module battery 42 and diode 34. Also shown is fuse 36, which is optional in this arrangement. Charge circuit 40 also may or may not be required depending upon the type and size of power module battery 42 used. For example, if an appropriately sized simple lead acid battery is deployed as power module battery 42, the charge circuit 40 may not be required. However, a charge circuit may be desirable for other types of batteries deployed as power module battery 42. The charge circuit 40 may comprise any of a number of different means for charging a rechargeable battery used in the field of battery charging. For example, the charging circuit could be as simple as a single resistor or it could be a switcher circuit used to limit the current or control the voltage provided to the battery. The type of charge circuit 40 selected by the practitioner in a particular implementation of the present invention will depend upon the type of power module battery 42 selected by the practitioner for the module, as some batteries respond better to fixed voltage charging, some respond better to fixed current charging, etc. In each case where a charge circuit is used, the charge circuit selected to correspond to the type of battery deployed as power module battery 42. Charge circuit 40 as shown may comprise a portion an overall master charging circuit controlling charging of both the power module battery 42 and the capacitor 30.

Another alternative arrangement for the electrical components in the module 20 is shown in FIG. 3F. Capacitor 30 and power module battery 42 are connected as was shown in the arrangement of FIG. 3A. An active charge/isolation circuit 45 is connected between the B(+) terminal 24 and the M(+) terminal 22 as shown. Active charge/isolation circuit 45 comprises an arrangement of active components selected to provide a charging and/or isolation function in the arrangement shown in FIG. 3F. For example, active charge/isolation circuit 45 may comprise a pulse wave modulator or DC chopper circuit and also circuitry that provides a voltage boost function. Charge circuit 40 also is shown for power module battery 42.

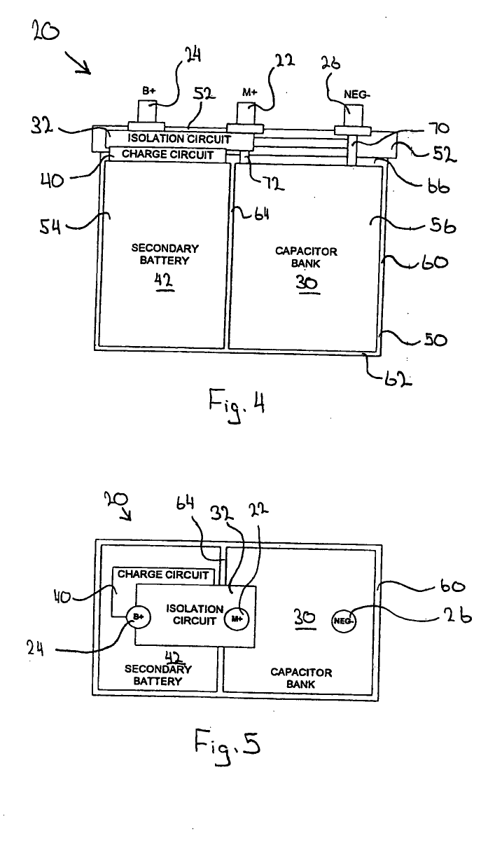

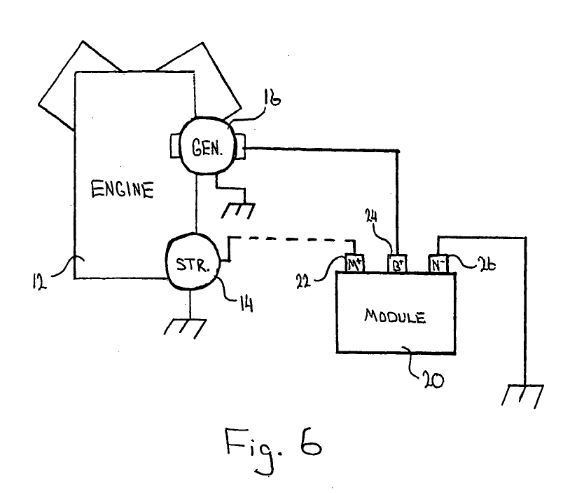

FIGS. 4 and 5 provide an exemplary arrangement for electronic components within the module. As shown in FIG. 4, the module includes a lower base 50 and an upper cap 52. The base 50 and upper cap 52 are both made of a nonconductive material that provides electrical insulation between the interior and exterior of the module. Such nonconductive materials are known in the art of battery manufacturing. The base 50 includes an exterior wall 60, a floor 62, a dividing wall 64, and a cover portion 66. The dividing wall 64 splits the base into two chambers. The first chamber 54 is designed and dimensioned to retain the power module battery 42. The second chamber 56 is designed and dimensioned to retain the capacitor or capacitor bank 30. A first post 70 is connected to the Neg(−) terminal 26, extends through the upper cap 52, and joins to the negative lead/terminal of the capacitor bank 30. A second post 72 is connected to the M(+) terminal 22, extends through the upper cap 52, and joins to the positive lead/terminal of the capacitor bank 30. A third post (not shown) is connected to the B(+) terminal 24, extends into the upper cap 52. The isolation circuit 32 is positioned in the upper cap 52 and connects the M(+) terminal 22 to the B(+) terminal 24 by extending between the second and third posts. The charge circuit 40 is positioned below the isolation circuit and provides the connection between the B(+) terminal 24 (and associated third post) and the positive lead of the power module battery 42. As explained previously, with reference to FIG. 3, the negative lead of the secondary battery is joined to the negative terminal. Altogether, the module 20 provides a compact unit housing all of the electrical components required for a supplementary current starting system in a motor vehicle. The module is compact and approximately the size of a typical vehicle battery, such that the module can be implemented into new or existing vehicle engine compartments.

In operation, the module is first connected to a vehicle's electrical system, as described above with reference to FIG. 1. The module 20 is put in use when the vehicle operator turns the key to the start position, and the ignition switch is closed. With the ignition switch closed, a connection between the starter 14 and the M(+) terminal 22 of the module is established. This allows current to flow from the capacitor 30 directly to the starter 14, and the engine 12 is cranked. The power module battery 42 may provide additional current during starting, especially if an unusually long cranking time is required to start the engine. Furthermore, some current may be provided by the vehicle's standard SLI (starting, lighting, ignition) vehicle battery 18, if the standard SLI vehicle battery 18 is sufficiently charged.

Once the engine starts following cranking, a substantial amount of energy has been drained from the capacitor, and the capacitor is ready for recharge. However, when the engine first starts, and is running at idle speed, there is typically not enough current generated from the charging system (i.e., alternator/generator) to completely re-charge the capacitor. If the vehicle's standard vehicle battery 18 and/or the power module battery 42 of the module are sufficiently charged, they may provide some immediate current for re-charging the capacitor. Alternatively, once the engine is operated at an increased speed above idle speed, the generator will provide current for recharging the battery (or batteries) and the capacitor. Because the capacitor 30 is an energy storing device that is capable of fast charge and discharge cycles, operation of the engine for only a short amount of time at speeds above idle speed (e.g., 20 seconds) will fully re-charge the capacitor 30.

During charging of the capacitor 30, energy flows through the fuse 36 and a diode 34 acting as the isolation circuit. During and after re-charging of the capacitor 30, the diode 34 of the isolation circuit 32 provides one-way flow of energy from the charging system to the capacitor 30 in the module. By providing isolation from the charging system, the module's energy cannot be drained back to the vehicle battery 18 while the vehicle is idling at a stop or if the engine is not running and there is an electrical load on the vehicle (flashers, radio, lighting, etc.). The fuse 36 protects the diode 34 and also serves as a safety device to disconnect the vehicle battery 18 from the starter 14 in the event of stuck contacts on the starting motor solenoid.

In an alternative embodiment shown in FIG. 6, the power module 20 completely replaces the vehicles standard/existing battery. In this embodiment, the module 20 includes a power module battery 42 which acts to replace the vehicle's standard battery. The size of the module 20 is sufficiently close to the size of the vehicle's standard battery that the module can simply be inserted in place of the vehicle's standard battery. For example, the module 20 may be sized to substantially correspond to the dimensions prescribed in a Battery Council International group number specification. Thus, the module 20 may be easily included in current vehicle designs and the module 20 may also be used as an easily installed aftermarket product. The embodiment of FIG. 6 could easily be used in vehicle applications with relatively small electrical loads, such as passenger cars and light trucks. However, the embodiment of FIG. 1 where the module (including a secondary battery) is used in association with the vehicle's standard battery may be more desirable for vehicles having larger on-board and off-board loads, such as recreational vehicles and heavy trucks.

As described above, the power module according to the present invention features short re-charge times which are particularly valuable in the delivery vehicle market. Because of low internal resistance, the capacitor banks are also capable of providing cranking current at a lower voltage than the battery. In addition, the module is continuously connected to the charging system of the vehicle, which makes implementation of the module in a vehicle relatively simple with no switching. The module may also take advantage of the presence of the secondary battery during starting, thereby allowing the module to be designed with smaller banks of capacitors. The module with a secondary battery is sized such that it can be used in place of a vehicle's standard battery, or it can be used to supplement the vehicle's standard battery. Furthermore, the existence of the module provides for longer battery life, as less reliance on the battery helps avoid extremely deep battery discharge.

Although the present invention has been described in considerable detail with reference to certain embodiments thereof, other versions are possible. For example, to protect the generator from the requirement of immediately operating at full load upon engine fire the until the capacitor has re-charged, the charge current to the capacitor may be limited by electronic means or by simply introducing some resistance to the isolation circuit (e.g., simply adding a resistor or choosing a diode with a ‘slow response’). As another example, if milling issues are noticed between the starter motor and flywheel due to the higher energy available from the use of capacitors as an energy storage device, resistance may be added to the lead/cable connecting the starter motor to the module (e.g., by making the leads longer, thus increasing the resistance in the connection and reducing the initial current the starting motor solenoid receives). Therefore, the spirit and scope of the appended claims should not be limited to the description of the embodiments contained herein.

1. A power module for use in conjunction with an automotive starter, the power module comprising:
an electrically conductive isolation device, said electrically conductive isolation device comprising a first connection point and a second connection point, wherein flow of electric current from said first connection point to said second connection point is permitted, and flow of electric current from said second connection point to said first connection point is resisted;
means for storing an electric charge, said means for storing an electric charge comprising a positive lead and a negative lead, said means for storing an electric charge having a capacitance of less than 321 farads, said positive lead electrically connected to said second connection point of said electrically conductive isolation device;
means for electrically connecting said positive lead to an external electric load;
means for electrically connecting said negative lead to ground; and
means for electrically connecting said first connection point of said electrically conductive isolation device to a positive terminal of an external DC voltage source.

2. The power module of claim 1, wherein said electrically conductive isolation device comprises a diode.

3. The power module of claim 1, wherein said electrically conductive isolation device comprises an arrangement of electrically interconnected active components.

4. The power module of claim 1, wherein said means for storing an electric charge comprises at least one electric double layer capacitor.

5. An automotive electrical system comprising:
a starter motor;
a generator;
a battery, said battery having a positive terminal and a negative terminal, said positive terminal electrically connected to said generator;
an electrically conductive isolation device, said electrically conductive isolation device comprising a first connection point and a second connection point, wherein flow of electric current from said first connection point to said second connection point is permitted, and flow of electric current from said second connection point to said first connection point is resisted, said first connection point of said electrically conductive isolation device electrically connected to said positive terminal of said battery, said first connection point of said electrically conductive isolation device electrically connected to said generator;
means for storing an electric charge, said means for storing an electric charge comprising a positive lead and a negative lead, said means for storing an electric charge having a capacitance of less than 321 farads, said positive lead electrically connected to said second connection point of said electrically conductive isolation device, said negative lead electrically connected to ground; and
means for electrically connecting said positive lead to said starter motor.

6. The automotive electrical system of claim 5, wherein said electrically conductive isolation device comprises a diode.

7. The automotive electrical system of claim 5, wherein said electrically conductive isolation device comprises an arrangement of electrically interconnected active components.

8. The automotive electrical system of claim 5, wherein said means for storing an electric charge comprises at least one electric double layer capacitor.

9. A power module for use in conjunction with an automotive starter, the power module comprising:
means for storing an electric charge, said means for storing an electric charge comprising a positive lead and a negative lead, said negative lead electrically connected to ground; and
a rechargeable DC voltage source comprising a positive terminal and a negative terminal, said negative terminal electrically connected to said negative lead, said rechargeable DC voltage source connected in parallel with said means for storing an electric charge,
wherein said means for storing an electric charge and said rechargeable DC voltage source are contained in unitary package.

10. The power module of claim 9, wherein said rechargeable DC voltage source comprises a deep cycle battery.

11. The power module of claim 9, wherein said unitary package is sized to correspond to dimensions prescribed in a Battery Council International group number specification.

12. The power module of claim 9, wherein said means for storing an electric charge comprises at least one electric double layer capacitor.

13. The power module of claim 9, further comprising, within said unitary package:
means for charging said rechargeable DC voltage source, said means for charging said rechargeable DC voltage source electrically connected to said rechargeable DC voltage source.

14. A power module for use in conjunction with an automotive starter, the power module comprising:
means for storing an electric charge, said means for storing an electric charge comprising a positive lead and a negative lead, said negative lead electrically connected to ground;
a rechargeable DC voltage source comprising a positive terminal and a negative terminal, said negative terminal electrically connected to said negative lead; and
an electrically conductive isolation device, said electrically conductive isolation device comprising a first connection point and a second connection point, wherein flow of electric current from said first connection point to said second connection point is permitted, and flow of electric current from said second connection point to said first connection point is resisted, said first connection point electrically connected to said positive terminal, said second connection point electrically connected to said positive lead,
wherein said means for storing an electric charge, said electrically conductive isolation device, and said rechargeable DC voltage source are contained in unitary package.

15. The power module of claim 14, wherein said unitary package is sized to correspond to the dimensions prescribed in a Battery Council International group number specification.

16. The power module of claim 14, further comprising:
means for charging said rechargeable DC voltage source, said means for charging said rechargeable DC voltage source electrically connected to said rechargeable DC voltage source.

17. The power module of claim 14, further comprising:
a voltage booster connected in parallel with said electrically conductive isolation device.

18. The power module of claim 14, wherein said electrically conductive isolation device comprises a diode.

19. The power module of claim 14, wherein said electrically conductive isolation device comprises an arrangement of electrically interconnected active components.

20. The power module of claim 14, wherein said means for storing an electric charge comprises at least one electric double layer capacitor.

21. The power module of claim 14, wherein said rechargeable DC voltage source comprises a deep cycle battery.

22. An automotive electrical system comprising:
a starter motor;
a generator; and
a unitary power module, said unitary power module comprising:
(i) an electrically conductive isolation device, said electrically conductive isolation device comprising a first connection point and a second connection point, wherein flow of electric current from said first connection point to said second connection point is permitted, and flow of electric current from said second connection point to said first connection point is resisted, said first connection point of said electrically conductive isolation device electrically connected to said generator,
(ii) means for storing an electric charge, said means for storing an electric charge comprising a positive lead and a negative lead, said positive lead electrically connected to said second connection point of said electrically conductive isolation device, said negative lead electrically connected to ground, and
(iii) a first battery, said first battery comprising a first positive terminal and a first negative terminal, said first negative terminal electrically connected to said negative lead, said first positive terminal electrically connected to said first connection point of said electrically conductive isolation device.

23. The automotive electrical system of claim 22, wherein said first battery comprises a deep cycle battery.

24. The automotive electrical system of claim 22, further comprising:
means for charging said first battery, said means for charging said first battery electrically connected to said first battery.

25. The automotive electrical system of claim 22, further comprising:
a voltage booster connected in parallel with said electrically conductive isolation device.

26. The automotive electrical system of claim 22, wherein said electrically conductive isolation device comprises a diode.

27. The automotive electrical system of claim 22, wherein said electrically conductive isolation device comprises an arrangement of electrically interconnected active components.

28. The automotive electrical system of claim 22, wherein said means for storing an electric charge comprises at least one electric double layer capacitor.

29. The automotive electrical system of claim 22, wherein said unitary package is sized to correspond to the dimensions prescribed in a Battery Council International group number specification.

30. The automotive electrical system of claim 22, further comprising:
a second battery, said second battery having a second positive terminal and a second negative terminal, said second positive terminal electrically connected to said generator, said second positive terminal electrically connected to said first connection point of said electrically conductive isolation device.

31. A power module for use in conjunction with an automotive starter, the power module comprising:
a diode, said diode comprising a first connection point and a second connection point, said diode biased to permit the flow of electric current from said first connection point to said second connection point and to resist the flow of electric current from said second connection point to said first connection point;
an electric double layer capacitor, said electric double layer capacitor comprising a positive lead and a negative lead, said positive lead electrically connected to said second connection point of said diode;
a deep cycle battery comprising a positive terminal and a negative terminal, said negative terminal electrically connected to said negative lead, said positive terminal electrically connected to said first connection point of said diode; and
means for charging said deep cycle battery, said means for charging said deep cycle battery electrically connected to said deep cycle battery, wherein said diode, said electric double layer capacitor, said deep cycle battery, and said means for charging said deep cycle battery are contained in unitary package.

32. A power module for use in conjunction with an automotive starter, the power module comprising:
an arrangement of electrically interconnected active components, said arrangement of electrically interconnected active components comprising a first connection point and a second connection point, said arrangement of electrically interconnected active components biased to permit the flow of electric current from said first connection point to said second connection point and to resist the flow of electric current from said second connection point to said first connection point;
an electric double layer capacitor, said electric double layer capacitor comprising a positive lead and a negative lead, said positive lead electrically connected to said second connection point of said arrangement of electrically interconnected active components;
a deep cycle battery comprising a positive terminal and a negative terminal, said negative terminal electrically connected to said negative lead, said positive terminal electrically connected to said first connection point of said arrangement of electrically interconnected active components; and
means for charging said deep cycle battery, said means for charging said deep cycle battery electrically connected to said deep cycle battery,
wherein said arrangement of electrically interconnected active components, said electric double layer capacitor, said deep cycle battery, and said means for charging said deep cycle battery are contained in unitary package.
